(19) United States
(12) Patent Application Publication
(10) Pub. No.: US 2021/0041743 A1
(43) Pub. Date: Feb. 11, 2021

(54) DISPLAY PANEL, METHOD FOR MANUFACTURING SAME, AND DISPLAY DEVICE

(71) Applicant: HKC CORPORATION LIMITED, Shenzhen (CN)

(72) Inventor: MENGTAO LI, Chongqing (CN)

(21) Appl. No.: 17/041,422

(22) PCT Filed: Dec. 12, 2018
(86) PCT No.: PCT/CN2018/120489

§ 371 Date: Sep. 24, 2020

(30) Foreign Application Priority Data
Nov. 26, 2018 (CN) 201811412612.6

(51) Int. Cl. G02F 1/1335

(52) U.S. Cl. CPC G02F 1/133516

(57) ABSTRACT

This application discloses a display panel, a method for manufacturing same, and a display device. The display panel includes a substrate and the substrate includes a color photoresist layer, including at least three color photoresist sub-layers of different colors and the color photoresist sub-layers are spaced apart from each other on the substrate; and a shading layer, located between neighboring color photoresist sub-layers, and including at least two shading sub-layers of different colors. The shading layer is formed by stacking the shading sub-layers and the shading sub-layers and the color photoresist sub-layers are made of a same material. The shading layer and the color photoresist layer have a same thickness.

This application claims the priority to the Chinese Patent Application No. CN201811412612.6, filed with National Intellectual Property Administration, PRC on Nov. 26, 2018 and entitled “DISPLAY PANEL AND METHOD FOR MANUFACTURING SAME, AND DISPLAY DEVICE”, which is incorporated herein by reference in its entirety.

### TECHNICAL FIELD

This application relates to the field of display technologies, and in particular to, a display panel, a method for manufacturing same, and a display device.

### BACKGROUND

Statement herein merely provides background information related to this application and does not necessarily constitute the existing technology.

With the development and advancement of science and technology, liquid crystal displays have various advantages such as thinness, power saving, and no radiation and are widely applied. Most of liquid crystal displays in the market are backlight-type liquid crystal displays, and the backlight-type liquid crystal display includes a liquid crystal panel and a backlight module. The liquid crystal panel includes a color film substrate (also referred to as Color Filter Substrate, CF Substrate) and a thin film transistor array substrate (Thin Film Transistor Substrate, TFT Substrate), transparent electrodes are provided on opposite inner sides of the substrates, and a layer of liquid crystal (Liquid Crystal, LC) molecules is sandwiched between the two substrates. The color film substrate as an important component of the liquid crystal panel generates various colors by mixing three primary colors of red, green, and blue according to the principle of light filtering, to implement color display of a liquid crystal device, and plays a key role in performance of the display panel such as viewing angle width, luminance, and resolution. The basic structure of the color film substrate includes a glass substrate, a black matrix, an RGB color photoresist layer, and a transparent electrode layer.

An uneven surface of the color film substrate causes non-uniformity in LC to produce color shift and low contrast.

### SUMMARY

This application provides a display panel, a method for manufacturing same, and a display device, to ensure a flat surface of a color film substrate and a narrow shading layer.

To achieve the foregoing objective, this application provides a display panel including a substrate. The substrate includes: a color photoresist layer, including at least three color photoresist sub-layers of different colors, where the color photoresist sub-layers are spaced apart from each other on the substrate: and a shading layer, located between neighboring color photoresist sub-layers, and including at least two shading sub-layers of different colors. The shading layer is formed by stacking the shading sub-layers and the shading sub-layers and the color photoresist sub-layers are made of a same material. The shading layer and the color photoresist layer have a same thickness.

Optionally, the shading layer includes a first shading sub-layer, a second shading sub-layer, and a third shading sub-layer, and the shading layer is formed by stacking the three shading sub-layers.

Optionally, a thickness of the color photoresist layer is between 1.5 μm to 3 μm, and a thickness of each of the first shading sub-layer, the second shading sub-layer, and the third shading sub-layer is between 0.5 μm to 1 μm.

Optionally, the first shading sub-layer, the second shading sub-layer, and the third shading sub-layer respectively correspond to colors of red, green, and blue.

Optionally, the first shading sub-layer, the second shading sub-layer, and the third shading sub-layer are stacked in sequence.

Optionally, each of the color photoresist sub-layers is integrated with a neighboring shading sub-layer of a same color.

Optionally, the first shading sub-layer, the second shading sub-layer, and the third shading sub-layer have a same thickness.

Optionally, the shading layer includes a fourth shading sub-layer and a fifth shading sub-layer and the shading layer is formed by stacking the fourth shading sub-layer and the fifth shading sub-layer.

Optionally, the fourth shading sub-layer and the fifth shading sub-layer respectively correspond to colors of red and blue.

Optionally, the fourth shading sub-layer and the fifth shading sub-layer have a same thickness.

Optionally, the shading sub-layer has a flat surface.

Optionally, a side surface of the shading sub-layer adjacent to the color photoresist sub-layer is flat.

Optionally, an optical density of the shading layer is greater than 4.

Optionally, the substrate is a color film substrate.

This application further discloses a method for manufacturing a display panel, including:
forming a color photoresist layer and a shading layer having a same thickness as that of the color photoresist layer on a substrate;
arranging the shading layer between neighboring color photoresist sub-layers, where the shading layer and the color photoresist sub-layers are made of a same material; and
forming, by using a mask, a first shading sub-layer and a corresponding color photoresist sub-layer, a second shading sub-layer and a corresponding color photoresist sub-layer, and a third shading sub-layer and a corresponding color photoresist sub-layer on the substrate, where
the used mask includes a first transparent area, configured to expose and develop the color photoresist layer at a position corresponding to the color photoresist layer, and a second translucent area, configured to expose and develop the shading layer at a position corresponding to the shading layer.

This application further discloses a display device, including a display panel and a drive circuit for driving the display panel. The display panel includes a substrate and the substrate includes a color photoresist layer, including at least three color photoresist sub-layers of different colors and the color photoresist sub-layers are spaced apart from each other on the substrate; and a shading layer, located between neighboring color photoresist sub-layers, and including a first shading sub-layer, a second shading sub-layer, and a third shading sub-layer, and the shading layer is formed by stacking the three shading sub-layers. The first shading sub-layer, the second shading sub-layer, and the third shading sub-layer have a same thickness. The shading sub-layers and the color photoresist sub-layers are made of a same material. The shading layer and the color photoresist layer have a same thickness.

Optionally, the shading layer includes a first shading sub-layer, a second shading sub-layer, and a third shading sub-layer, and the shading layer is formed by stacking the three shading sub-layers.

Optionally, each of the color photoresist sub-layers is integrated with a neighboring shading sub-layer of a same color.

Optionally, the first shading sub-layer, the second shading sub-layer, and the third shading sub-layer have a same thickness.

In this application, the shading layer includes at least two shading sub-layers of different colors, and the shading sub-layers and the color photoresist sub-layers are made of a same material. Because the color photoresist layer can only let light of a same color travel through, the shading layer cannot let the light travel through, so as to achieve an effect of a black matrix. In addition, a material of a shading layer is usually a black matrix. Therefore, to avoid light leakage, the black matrix is processed to be wide enough to squeeze a color photoresist layer to form a bulge, so as to cause non-uniformity in LC to generate color shift. In this application, a shading layer and a color photoresist layer are made of a same material, and the shading layer and the color photoresist layer have a same thickness, so as to avoid color shift caused by non-uniformity in LC.

### BRIEF DESCRIPTION OF DRAWINGS

The drawings included are used for providing understanding of embodiments of this application, constitute part of the specification, and are used for illustrating implementation manners of this application, and interpreting principles of this application together with text description. Apparently, the accompanying drawings in the following descriptions are merely some embodiments of this application, and a person of ordinary skill in the art can also obtain other accompanying drawings according to these accompanying drawings without involving any creative effort. In the accompanying drawings:

FIG. 1 is a schematic diagram of a section of a substrate having a shading layer being a black matrix.

FIG. 2 is a schematic diagram of a process for manufacturing a display panel having a shading layer being a black matrix.

FIG. 3 is a schematic diagram of a section of a substrate having a shading layer including two shading sub-layers according to an embodiment of this application.

FIG. 4 is a schematic diagram of a section of a substrate having a shading layer including three shading sub-layers according to an embodiment of this application.

FIG. 5 is a schematic diagram of a process for manufacturing a display panel having a shading layer including three shading sub-layers according to an embodiment of this application.

FIG. 6 is a schematic diagram of a section in a process for manufacturing a display panel having a shading layer including three shading sub-layers according to an embodiment of this application.

FIG. 7 is a schematic diagram of a mask of a display panel according to an embodiment of this application.

FIG. 8 is a simple schematic diagram of a display device according to an embodiment of this application.

### DETAILED DESCRIPTION OF EMBODIMENTS

Specific structures and functional details disclosed herein are merely representative, and are intended to describe the objectives of exemplary embodiments of this application. However, this application may be specifically implemented in many alternative forms, and should not be construed as being limited to the embodiments set forth herein.

In the description of this application, it should be understood that orientation or position relationships indicated by the terms such as “center”, “transverse”, “on”, “below”, “left”, “right”, “vertical”, “horizontal”, “top”, “bottom”, “inside”, and “outside” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as limiting of this application. In addition, the terms such as “first” and “second” are used only for the purpose of description, and should not be understood as indicating or implying the relative importance or implicitly specifying the number of the indicated technical features. Therefore, a feature defined by “first” or “second” can explicitly or implicitly includes one or more of said features. In the description of this application, unless otherwise stated, “a plurality of” means two or more than two. In addition, the terms “include”, “comprise” and any variant thereof are intended to cover non-exclusive inclusion.

In the description of this application, it should be noted that unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. Persons of ordinary skill in the art may understand the specific meanings of the foregoing terms in this application according to specific situations.

The terminology used herein is for the purpose of describing specific embodiments only and is not intended to be limiting of exemplary embodiments. As used herein, the singular forms “a”, “an” and “the” are intended to include the plural forms as well, unless the context clearly indicates otherwise. It should be further understood that the terms “include” and/or “comprise” when used in this specification, specify the presence of stated features, integers, steps, operations, units and/or components, but do not preclude the presence or addition of one or more other features, integers, steps, operations, units, components, and/or combinations thereof.

This application is described below with reference to the accompanying drawings and optional embodiments.

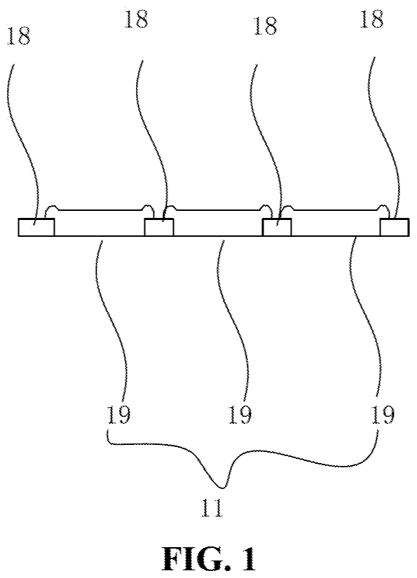

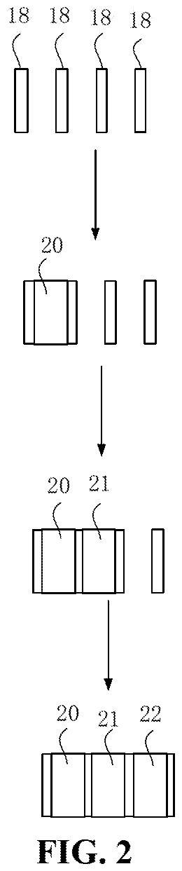

As shown in FIG. 1 and FIG. 2, if a shading layer 12 of a display panel 26 is a black matrix 18, a color film substrate first forms the black matrix 18 and then forms a color photoresist layer 11. The color photoresist layer 11 is overlapped with the black matrix 18 to some extent to generate an angle. As a result, an uneven surface of the color film substrate causes non-uniformity in LC to produce color shift and low contrast. In addition, due to the overlapped part of the color photoresist layer 11 and the black matrix 18, the black matrix 18 cannot be thinned, and the aperture ratio is low.

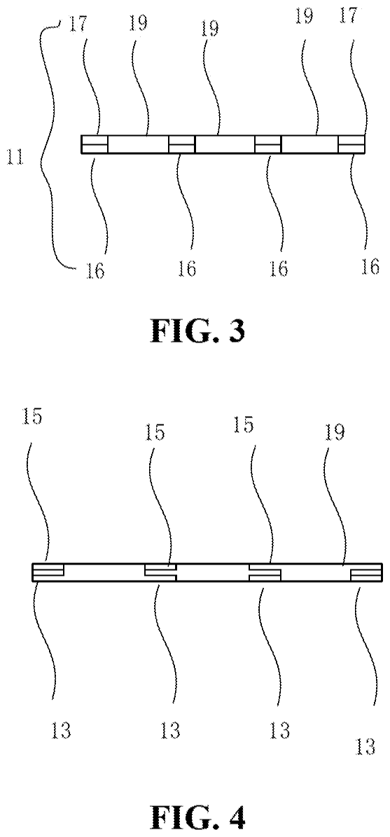

As shown in FIG. 3 and FIG. 4, an embodiment of this application provides a display panel 26. The display panel 26 includes a substrate 10. The substrate 10 is a color film substrate. The color film substrate includes: a color photoresist layer 11, including at least three color photoresist sub-layers 19 of different colors, where the color photoresist sub-layers 19 are spaced apart from each other on the color film substrate; and a shading layer 12, located between neighboring color photoresist sub-layers 19, including at least two shading sub-layers of different colors. The shading layer 12 is formed by stacking the shading sub-layers and the shading sub-layers and the color photoresist sub-layers 19 are made of a same material. The shading layer 12 and the color photoresist layer 11 have a same thickness.

In this solution, because the color photoresist layer 11 can only let light of a same color travel through, the shading layer 12 includes at least two shading sub-layers of different colors, and the shading sub-layers and the color photoresist sub-layers 19 are made of a same material, the shading layer 12 cannot let light travel through, to achieve an effect of the black matrix 18. In addition, a material of a shading layer 12 is usually a black matrix 18. To avoid light leakage, the black matrix 18 is processed to be wide enough to squeeze a color photoresist layer 11 to form a bulge, so as to cause non-uniformity in LC to generate color shift. In this application, a shading layer 12 and a color photoresist layer 11 are made of a same material, and the shading layer 12 and the color photoresist layer 11 have a same thickness, so as to avoid color shift caused by non-uniformity in LC.

In one or more embodiments, the shading layer 12 includes a first shading sub-layer 13, a second shading sub-layer 14, and a third shading sub-layer 15, and the shading layer 12 is formed by stacking the three shading sub-layers.

A thickness of the color photoresist layer 11 is between 1.5 μm to 3 μm, and a thickness of each of the first shading sub-layer 13, the second shading sub-layer 14, and the third shading sub-layer 15 is between 0.5 μm to 1 μm.

In this solution, the shading layer 12 is formed by stacking the three shading sub-layers. Generally, stacking of two shading sub-layers can achieve a light shading effect, and the shading layer 12 formed by stacking the three shading sub-layers is used, which is equivalent to addition of one more light filtering effect, so that the light can travel through more difficulty. The color photoresist sub-layers 19 are usually of three types. Three types of color photoresist sub-layers 19 are used to form three different shading sub-layers. The shading layer 12 formed by stacking the three shading sub-layers can achieve a best light shading effect. In this way, even if a quantity of shading sub-layers is increased, a desired light shading effect cannot be achieved.

In one or more embodiments, the color photoresist layer 19 includes a first color photoresist sub-layer 20, a second color photoresist sub-layer 21, and a third color photoresist sub-layer 22, respectively corresponding to colors of red, green, and blue.

The first shading sub-layer 13, the second shading sub-layer 14, and the third shading sub-layer 15 are stacked in sequence.

In this solution, the sequence of a process for manufacturing the color photoresist layer 19 is usually made in accordance with the sequence of colors of red, green and blue. Therefore, a stacking sequence of the shading sub-layers is arranged in consistent with the sequence of the process for manufacturing the color photoresist layer. In this way, the color photoresist layer 19 and the shading layer 12 are simultaneously formed, so as to reduce steps of the manufacturing process and improve the efficiency.

In one or more embodiments, each of the color photoresist sub-layers 19 is integrated with a neighboring shading sub-layer of a same color.

In this solution, because each of the color photoresist sub-layers 19 is integrated with a neighboring shading sub-layer of a same color, two shading sub-layers can be processed when the color photoresist layer 11 is processed, so as to reduce manufacturing procedures and save costs.

In one or more embodiments, the first shading sub-layer 13, the second shading sub-layer 14, and the third shading sub-layer 15 have a same thickness.

In this solution, because the three shading sub-layers have a same thickness, and a thickness of each shading sub-layer equals to one-third that of an optical resistance layer, control is easy during exposure and development and processing is easy.

In one or more embodiments, the shading layer 12 includes a fourth shading sub-layer 16 and a fifth shading sub-layer 17 and the shading layer 12 is formed by stacking the fourth shading sub-layer 16 and the fifth shading sub-layer 17.

In this solution, the color photoresist layer 19 needs to pass through three masks to respectively form three color photoresist sub-layers. Therefore, if a shading sub-layer is simultaneously formed in a mask manufacture procedure of a corresponding color photoresist sub-layer 19, a corresponding mask needs to be formed again. This technical solution only provides two shading sub-layers. Therefore, only masks corresponding to two color photoresist sub-layers need to be changed, and a mask corresponding to a third color photoresist sub-layer 19 does not need to be changed, so as to save the costs.

In one or more embodiments, the fourth shading sub-layer 16 and the fifth shading sub-layer 17 respectively correspond to colors of red and blue.

In this solution, because colors of red and blue have longer wavelengths, the fourth shading sub-layer 16 and the fifth shading sub-layer 17 are respectively made in the colors of red and blue, and light of other colors is uneasy to travel through, so as to provide desired shading.

In one or more embodiments, the fourth shading sub-layer 16 and the fifth shading sub-layer 17 have a same thickness. In this solution, the fourth shading sub-layer 16 and the fifth shading sub-layer 17 are made to have a same thickness, which helps maintain uniformity and facilitates processing.

In one or more embodiments, the shading sub-layer has a flat surface.

In this solution, because the shading sub-layer has the flat surface, and a height of stacked shading sub-layers is closer to that of the color photoresist layer 11, the substrate 10 has a more flat surface, LC distributed on the substrate is more uniform, and color shift is smaller.

In one or more embodiments, a side surface of a shading sub-layer adjacent to a color photoresist sub-layer is flat.

In this solution, because the side surface of the shading sub-layer adjacent to the color photoresist sub-layer is flat, a contact gap between a side surface of the shading sub-layer and a side surface of the color photoresist sub-layer 19 is too small to let the light travel through, so as to avoid light leakage.

In one or more embodiments, an optical density (OD) of the shading layer 12 is greater than 4.

In this solution, the value of the optical density usually indicates the light shading effect. A greater optical density indicates a desired light shading effect. A smaller optical density indicates a higher light transmittance. In this case, light leakage is easily to be caused and the quality of display is affected. Generally, only when the optical density of the shading layer 12 is greater than 4, enough shading performance can be provided to shade a metal trace corresponding to a position of the shading layer 12.

In one or more embodiments, a translucent mask is used in this application, and after exposure, an area of a normal film thickness, namely, a color photoresist layer (approximately 1.5 to 3 μm) and a thin area, namely, a shading sub-layer (approximately 0.5 to 1 μm) are formed.

As shown in FIG. 3 and FIG. 4, in another embodiment of this application, a display panel 26 is further disclosed. The display panel 26 includes a substrate 10 and the substrate 10 includes: a color photoresist layer 11, including at least three color photoresist sub-layers 19 of different colors, where the color photoresist sub-layers 19 are spaced apart from each other on the substrate 10; and a shading layer 12, located between neighboring color photoresist sub-layers 19, and including a first shading sub-layer 13, a second shading sub-layer 14, and a third shading sub-layer 15, where the shading layer 12 is formed by stacking the three shading sub-layers. The first shading sub-layer 13, the second shading sub-layer 14, and the third shading sub-layer 15 have a same thickness. The shading sub-layers and the color photoresist sub-layers 19 are made of a same material. The shading layer 12 and the color photoresist layer 11 have a same thickness.

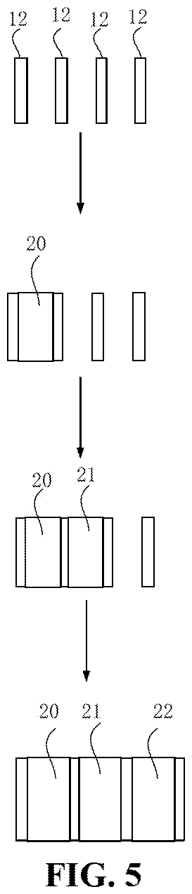

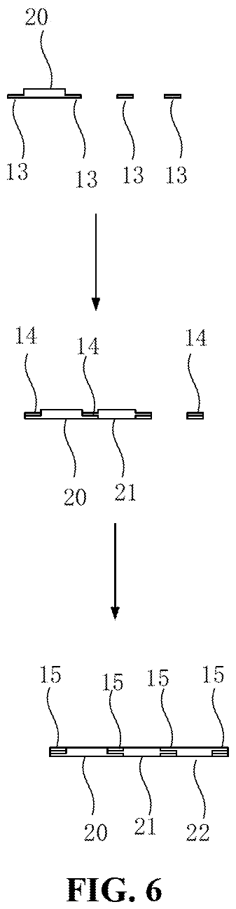

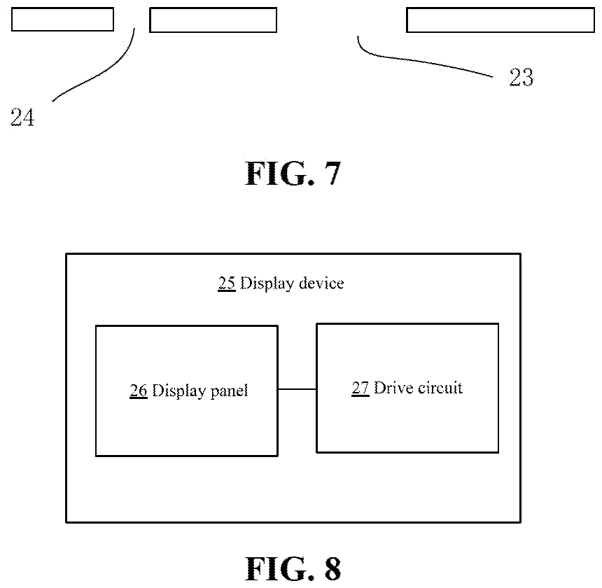

As shown in FIG. 5 to FIG. 7, another embodiment of this application discloses a method for manufacturing a display panel 26, including: forming a color photoresist layer 11 and a shading layer 12 having a same thickness as that of the color photoresist layer 11 on a substrate 10; arranging the shading layer 12 between neighboring color photoresist sub-layers 19, where the shading layer 12 and the color photoresist sub-layers 19 are made of a same material; and forming, by using a mask, a first shading sub-layer 13 and a corresponding color photoresist sub-layer 19, a second shading sub-layer 14 and a corresponding color photoresist sub-layer 19, and a third shading sub-layer 15 and a corresponding color photoresist sub-layer 19 on the substrate 10. The used mask includes a first transparent area 23, configured to expose and develop the color photoresist layer 11 at a position corresponding to the color photoresist layer 11, and a second translucent area 24, configured to expose and develop the shading layer 12 at a position corresponding to the shading layer 12.

In another embodiment of this application, as shown in FIG. 3 to FIG. 8, a display device 25 is disclosed, including the foregoing display panel 26 and a drive circuit 27 for driving the display panel 26.

The technical solutions of this application can be widely used in various display panels such as a Twisted Nematic (TN) display panel, an In-Plane Switching (IPS) display panel, and a Multi-Domain Vertical Alignment (VA) display panel, and may certainly be any other type of display panel such as an Organic Light Emitting Diode (OLED) display panel. All these are applicable to the foregoing solutions.

The foregoing content describes this application in detail with reference to the specific implementation manners, and it should not be regarded that the specific implementations of this application are limited to these descriptions. Persons of ordinary skill in the art can further make simple deductions or replacements without departing from the concept of this application, and such deductions or replacements should all be considered as falling within the protection scope of this application.

What is claimed is:

1. A display panel, comprising a substrate, wherein the substrate comprises:
a color photoresist layer, comprising at least three color photoresist sub-layers of different colors, wherein the color photoresist sub-layers are spaced apart from each other on the substrate; and
a shading layer, located between neighboring color photoresist sub-layers, and comprising at least two shading sub-layers of different colors, wherein the shading layer is formed by stacking the shading sub-layers and the shading sub-layers and the color photoresist sub-layers are made of a same material, wherein
the shading layer and the color photoresist layer have a same thickness.

2. The display panel according to claim 1, wherein the shading layer comprises a first shading sub-layer, a second shading sub-layer, and a third shading sub-layer, and the shading layer is formed by stacking the three shading sub-layers.

3. The display panel according to claim 2, wherein a thickness of the color photoresist layer is between 1.5 μm to 3 μm, and a thickness of each of the first shading sub-layer, the second shading sub-layer, and the third shading sub-layer is between 0.5 μm to 1 μm.

4. The display panel according to claim 2, wherein the first shading sub-layer, the second shading sub-layer, and the third shading sub-layer respectively correspond to colors of red, green, and blue.

5. The display panel according to claim 4, wherein the first shading sub-layer, the second shading sub-layer, and the third shading sub-layer are stacked in sequence.

6. The display panel according to claim 2, wherein each of the color photoresist sub-layers is integrated with a neighboring shading sub-layer of a same color.

7. The display panel according to claim 2, wherein the first shading sub-layer, the second shading sub-layer, and the third shading sub-layer have a same thickness.

8. The display panel according to claim 1, wherein the shading layer comprises a fourth shading sub-layer and a fifth shading sub-layer and the shading layer is formed by stacking the fourth shading sub-layer and the fifth shading sub-layer.

9. The display panel according to claim 8, wherein the fourth shading sub-layer and the fifth shading sub-layer respectively correspond to colors of red and blue.

10. The display panel according to claim 8, wherein the fourth shading sub-layer and the fifth shading sub-layer have a same thickness.

11. The display panel according to claim 1, wherein the shading sub-layer has a flat surface.

12. The display panel according to claim 1, wherein a side surface of the shading sub-layer adjacent to the color photoresist sub-layer is flat.

13. The display panel according to claim 1, wherein an optical density of the shading layer is greater than 4.

14. The display panel according to claim 1, wherein the substrate is a color film substrate.

15. A method for manufacturing a display panel, comprising steps:
forming a color photoresist layer and a shading layer having a same thickness as that of the color photoresist layer on a substrate;
arranging the shading layer between neighboring color photoresist sub-layers, wherein the shading layer and the color photoresist sub-layers are made of a same material; and
forming, by using a mask, a first shading sub-layer and a corresponding color photoresist sub-layer, a second shading sub-layer and a corresponding color photoresist sub-layer, and a third shading sub-layer and a corresponding color photoresist sub-layer on the substrate, wherein
the used mask comprises a first transparent area, configured to expose and develop the color photoresist layer at a position corresponding to the color photoresist layer, and a second translucent area, configured to expose and develop the shading layer at a position corresponding to the shading layer.

16. A display device, comprising a display panel and a drive circuit for driving the display panel, wherein the display panel comprises a substrate, and the substrate comprises:
a color photoresist layer, comprising at least three color photoresist sub-layers of different colors, wherein the color photoresist sub-layers are spaced apart from each other on the substrate; and
a shading layer, located between neighboring color photoresist sub-layers, and comprising at least two shading sub-layers of different colors, wherein the shading layer is formed by stacking the shading sub-layers and the shading sub-layers and the color photoresist sub-layers are made of a same material, wherein
the shading layer and the color photoresist layer have a same thickness.

17. The display device according to claim 16, wherein the shading layer comprises a first shading sub-layer, a second shading sub-layer, and a third shading sub-layer, and the shading layer is formed by stacking the three shading sub-layers.

18. The display device according to claim 16, wherein each of the color photoresist sub-layers is integrated with a neighboring shading sub-layer of a same color.

19. The display device according to claim 16, wherein the first shading sub-layer, the second shading sub-layer, and the third shading sub-layer have a same thickness.
